(19) United States
(12) Patent Application Publication
(10) Pub. No.: US 2010/0267430 A1
(43) Pub. Date: Oct. 21, 2010

(54) APPARATUS HAVING A SEMI AUTOMATED SLIDER

(75) Inventor: Pasi Kemppinen, Tampere (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/809,979

(22) PCT Filed: Dec. 20, 2007
(86) PCT No.: PCT/FI07/00300

§ 371 Date: Jun. 21, 2010

(51) Int. Cl. H04M 1/00

(52) U.S. Cl. 455/575.4

(57) ABSTRACT

Various embodiments of the invention disclose an apparatus, for example a mobile phone, comprising a first part and a second part. The first part is slidably and resiliently connected to said second part. The apparatus comprises further a third part, which can be a shuttle part or a cradle part, which third part is advantageously configured to enable the semi-automatic or telescopic opening of the apparatus. Thus relatively small movement of the third part enables generally larger movement of the first part, thereby opening or closing the apparatus semi-automatically. Furthermore the visible and usable portion of the first part of the apparatus can increase and decrease by the control of the relative small movement of the shuttle. The first part can be a sliding cover of the apparatus and the second part a body of the apparatus.

### TECHNICAL FIELD OF THE INVENTION

The invention concerns an apparatus comprising a semi-automatic opening and closing mechanism. Furthermore the invention concerns a wireless apparatus comprising a semi-automatic opening and closing mechanism.

### BACKGROUND

Modern society has quickly adopted, and become reliant upon, handheld apparatuses for wireless communication. For example, cellular telephones continue to proliferate in the global marketplace due to technological improvements in both the communication quality and device functionality. These wireless communication apparatuses have become common for both personal and business use, allowing users to transmit and receive voice, text and graphical data from a multitude of geographic locations. The communication networks utilized by these apparatuses span different frequencies and cover different transmission distances, each having strengths desirable for various applications. The apparatuses are conveniently small and handheld. At the same time they nevertheless have significant display capabilities. This has created a problem for fitting a big enough display into the apparatus and still meet the demanding design requirements for the tiny handheld feeling.

A known solution for the problem has been presented in a mobile phone, wherein the slide opens so that the user pulls the slide downwards. The mobile phone has two parts that are arranged to slide with respect to each other: the slide and the body part. Display opens out under the slide. When the slide is in closed position, there is a small window like space that is left for viewing a portion of the display.

### SUMMARY

It is the object of the invention to meet the design requirements for handheld apparatuses and improve the display output.

In accordance with an aspect of the invention there is provided an apparatus, comprising:

a first part,
a second part, wherein the first part is arranged to be slidably and resiliently connected with the second part, and
a third part configured to move the first part with respect to the second part in a direction wherein the first part is configured for movement relative to the third part along a path in the direction.

In accordance with another aspect of the invention there is provided a wireless apparatus, comprising:

a first part,
a second part, wherein the first part is arranged to be slidably and resiliently connected to the second part, and
a third part configured to move the first part with respect to the second part in a direction wherein the first part is configured for movement relative to the third part along a path in the direction.

Various embodiments of the invention disclose a wireless apparatus, for example a mobile phone, comprising a first part and a second part. The first part is slidably connected to said second part. The apparatus comprises further a third part, which can be a shuttle part or a cradle part, which third part is advantageously configured to enable the semi-automatic or telescopic opening of the apparatus. Thus relatively small movement of the third part enables generally larger movement of the first part, thereby opening or closing the apparatus semi-automatically. Furthermore the visible and usable portion of the first part of the apparatus can increase and decrease by the control of the relative small movement of the shuttle.

### BRIEF DESCRIPTION OF THE DRAWINGS

Various further embodiments of the invention will now be described, by way of examples only, with reference to the accompanying drawings, in which:

FIG. 1 depicts a known apparatus,

FIGS. 2a and 2b depict top views of the apparatus in a closed position in FIG. 2a and in an open position in FIG. 2b according to various embodiments of the invention,

FIG. 3 depicts cross sections of the apparatuses illustrating the opening of the semi-automatic slider according to various embodiments of the invention,

FIGS. 4a and 4b depict zoomed cross sections of examples of stoppers according to some further embodiments of the invention,

FIG. 5 depicts another example of the apparatus in the open position showing also the cross-sections of the stoppers according to various further embodiments of the invention,

FIG. 6 depicts another example of the apparatus in the closed position showing also the cross-sections of the stoppers according to various further embodiments of the invention, and

FIG. 7 depicts a top view of the cross-section of the apparatus, wherein stoppers have been depicted in accordance with further embodiments of the invention.

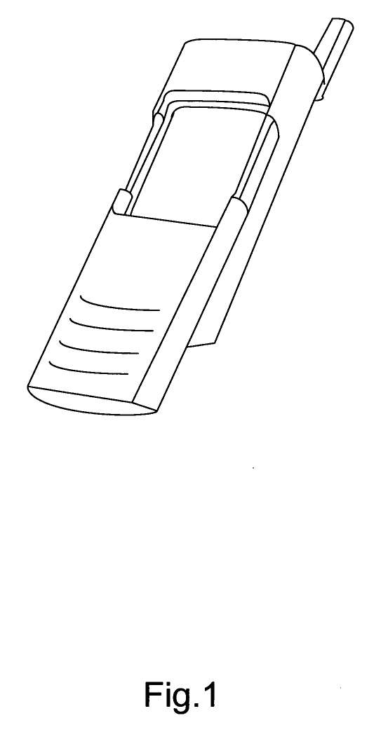

### DESCRIPTION OF FURTHER EMBODIMENTS

Various embodiments of the invention provide an apparatus that has a slide mechanism with an additional part such as a shuttle part (alternatively referred to as a cradle). The shuttle part can contain a keypad part. The apparatus comprises the slider, which may be a first part. In an embodiment of the invention the slider may be a lid or cover of the apparatus, which is slidably connected to the body of the apparatus. The slider comprises a portion of the output means of the apparatus such as s display.

The apparatus comprises a body, which may be referred to as a second part. The apparatus comprises the shuttle, which may be referred to as a third part. When the user moves the shuttle, the slider begins to move. The movement of the shuttle moves the slider further according to the resilient arrangement between the slider and the body. Thereby the slider moves more by the lesser movement of the shuttle. Advantageously more display is opened out as compared to mere movement of the slider as such. Advantageously in further embodiments a relatively very short push is needed so that the lid opens itself all the way. This kind of slide mechanism can be regarded as a pop-up mechanism, telescopic mechanism or a semi-automatic mechanism.

In various further embodiments, the apparatus may be a wireless radio frequency apparatus having a wireless communications capability. The apparatus can be, according to a further embodiment, a cellular mobile phone such a third generation mobile apparatus. The body comprises a full keypad of the wireless apparatus. The slider has a major portion of the display of the wireless apparatus, and the shuttle contains a mini keypad.

Various embodiments of the figures are intended to reflect the relative portions of the parts. Thereby the figures may be depicted in measures for depicting the various embodiments of the contribution of the invention.

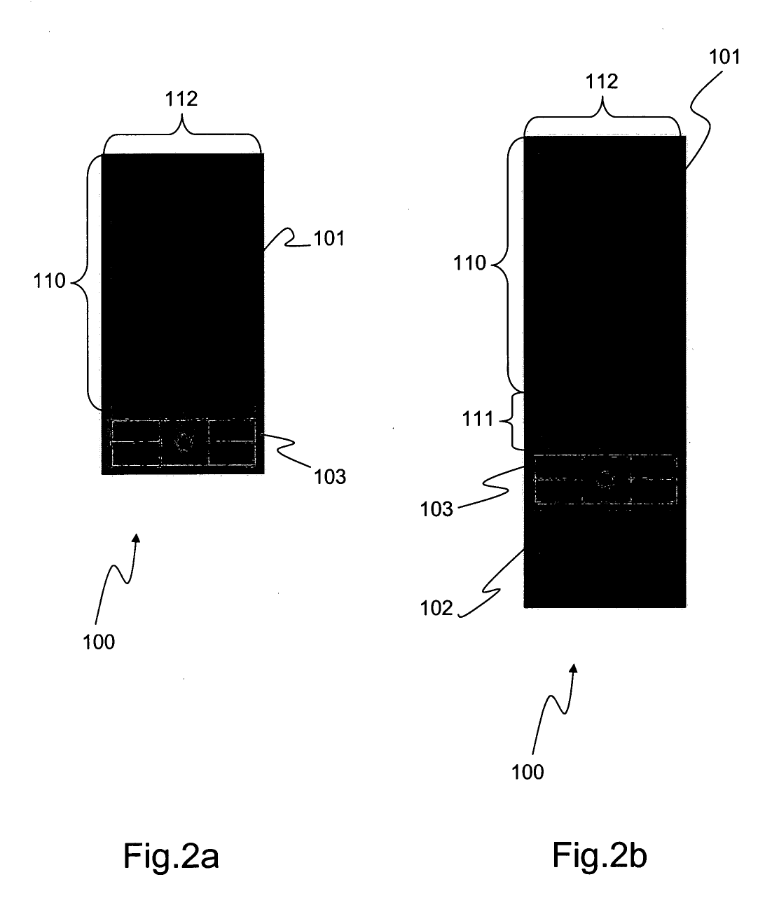

As referred above FIG. 2a depicts a top view of the apparatus 100 in a closed position according to various embodiments of the invention. The apparatus 100 comprises a first part 101. In various embodiments the first part 101 is a slider, for example a cover of the apparatus 100, containing an output portion of the apparatus 100. The output portion can be a display for example. The apparatus 100 comprises also a shuttle 103. In some further embodiments the shuttle 103 comprises a portion of a keypad. Thereby at least a portion of the keypad can be always visible or available to the user, even though the apparatus 100 would be relatively short and the first part containing the output portion 101 very large and partly hidden. In the FIG. 2a the apparatus 100 is in the closed mode or closed position. A length 110 of the output portion 101 is shown. Thus the user can for example see the portion of the display having the length 110. In a further embodiment of the invention advantageously the dimension 110 along with the width 112 correspondences with 4:3 aspect ratio. Thus the dimension of the display with respect to the width of the display correspondences with the aspect ration 4:3. Advantageously this may be for example used at vga displays or at conventional tv's.

FIG. 2b depicts a top view of the apparatus 100 in an open position according to various embodiments of the invention. The first part 101 is arranged to slide further, by a further length 111, with respect to a second part 102 now showing in the FIG. 2b. Advantageously the length of the output portion of the first part 101 has been increased by the further length 111. Furthermore the second part 102 is now partly visible. The second part 102 contains normal ITU keypad of the apparatus 100. The ITU keypad is now ready for use. In a further embodiment of the invention advantageously the length 110 and the further length 111 along with the width 112 correspondences with 16:9 aspect ration. Thus the combined length of the display (the length 110 plus the further length 111) with respect to the width of the display correspondences with the aspect ration 16:9. Advantageously this may be for example used at widescreen displays or the like. In yet another further embodiment the further length 111 may be 12 mm, thus extra 12 mm can be revealed, when the slider 101 is opened.

In various embodiments of the invention advantageously the keypad is always visible on the shuttle 103 although the apparatus 100 would be relatively short and display portion at the slider 101 relatively large.

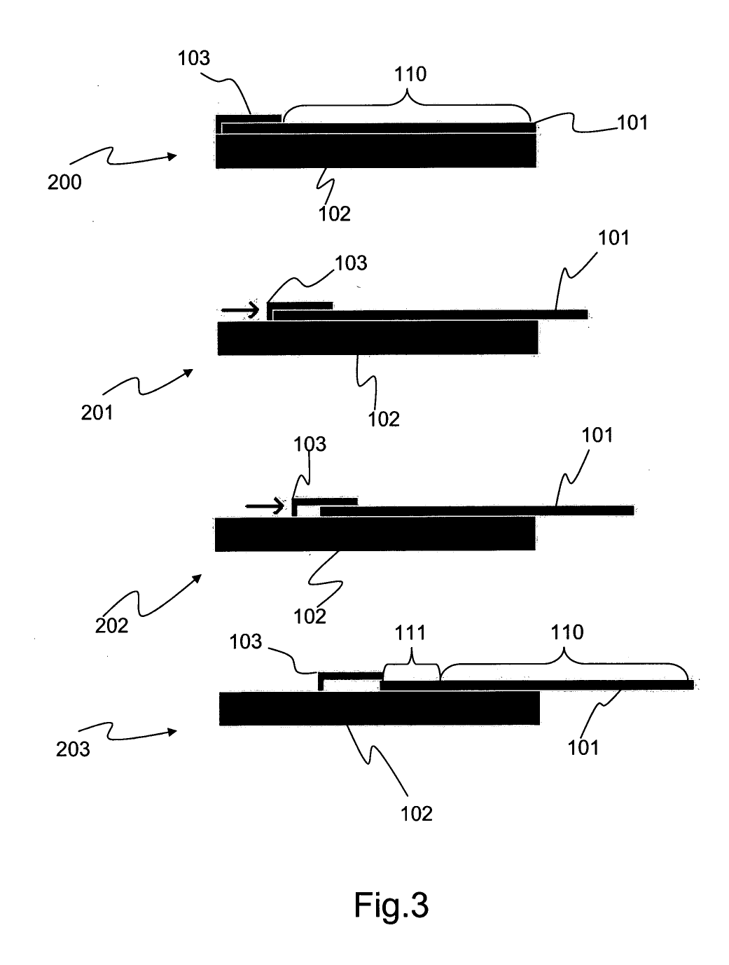

Referring to the FIG. 3 there is being depicted cross sections of the apparatuses illustrating the opening of the semi-automatic slider according to various embodiments of the invention. In the position 200 the apparatus 100 is in the closed mode. In the closed mode the shuttle 103 joins smoothly to slider part 101, which thus contain the display portion. In some further embodiments the shuttle 103 may continue quite much longer than the figures depicts. In the position 201 the shuttle 103 begins to move. The user can move the shuttle 103. The shuttle 103 begins to move the slider part 101. The slider part 101 slides with respect to the body part 102. The shuttle 103 slides also with respect to the body part 102. The slider 101 moves over the body part 102 as shown in the figure. The resilient connection between the slider 101 and the body 102 opposes the movement at the position 201. Thereby without the moving force, e.g. the push of the user, the slider 101 and the shuttle 103 would move back into the closed position 200. In an embodiment at least one spring is configured between the slider 101 and the body 102 so that it opposes the opening at the position 201 and tends to move the apparatus into the closed mode. The resilient connection between the slider 101 and the body 102 is configured to oppose the opening of the slider 101 until a certain position, which may be referred to as an equilibrium position or a dead-center position (may also be alternatively referred to as a dead point position). In the equilibrium position the opposing closing force changes into an opening force so that the opening force tends to move the slider 101 (and the cradle 103) into the open position 203. This is due to the configuration of the resilient connection between the slider 101 and the body 102. For example the spring may be configured between the slider 101 and the body 102 so that the opposing force is converted into the opening force once the equilibrium position is meet. In the position 202 the equilibrium position has been passed. The opening force by the resilient connection tends to open the slider 101. The slider 101 has been disengaged from an end of the cradle 103 as shown in the position 202. The resilient connection drags the slider 101 towards the open position. The slider 101 is arranged to move the shuttle 103 by the mechanical configuration such as a friction for example. In various embodiments advantageously around the position 202 the slider 101 opens automatically. Due to the configuration of the slider 101 and the shuttle 103, advantageously the apparatus 100 is arranged to open telescopically.

In the position 203 the slider part 101 extends further by the length 111. The slider part 101 is configured to extend further by the union point of the slider 101 and the shuttle 103. Alternatively the union point can be situated at an open end the slide part 101 so that the shuttle 103 is relatively long. The apparatus 100 is at open mode in the position 203. The resilient connection between the slider part 101 and the body part 102 is arranged to keep the apparatus 100 at the open position. For example the spring is configured so that the spring pushed the slider part 101 further and a stopper stops the movement at the open mode position 203. A stopper also stops the movement of the shuttle 103. Furthermore another stopper stops the movement between the shuttle 103 and the slide part 101.

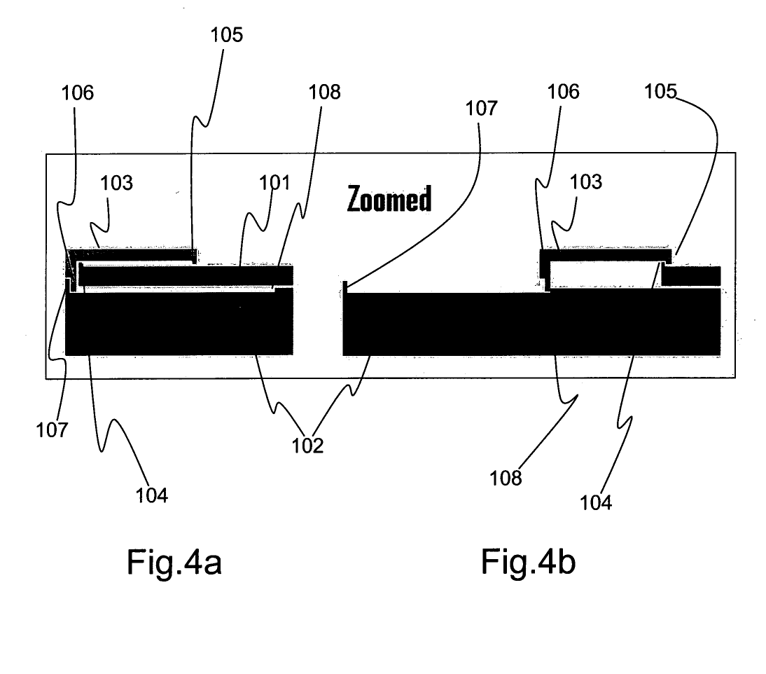

FIGS. 4a and 4b depicts zoomed cross sections of examples of stoppers according to some further embodiments of the invention. FIG. 4a shows the zoomed details the shuttle 103 in the closed position according to the further embodiments. The shuttle 103 contains a first stopper 105 and a second stopper 106. The stoppers 105 and 106 are situated at the end of the shuttle as shown in the FIGS. 4a and 4b. In the closed mode the second stopper 106 is configured to stop the movement of the first part 101. Furthermore the second stopper 106 is configured to come across with a stopper 107 of the second part 102. Therefore the second stopper 106 stops the movement of the shuttle 103 against the stopper 107. The stoppers 106 and 107 thus limit the movement of the shuttle 103 and the first part 101 in the closed mode, wherein the movement is caused by the closing force of the resilient connection between the first 101 and the second part 102. Also an end of the first part 101 limits the movement by encountering the stopper 106 and the end of the shuttle 103. The end of the first part 101 and the stopper 104 are pressed against the end of the shuttle 103 and the stopper 106. Furthermore the pressure is conveyed by the stopper 106 to the stopper 107.

FIG. 4b shows the zoomed details the cradle 103 in the open mode according to the further embodiments. In the open mode the resilient connection between the first 101 and the second part 102 tends to move the parts apart from each other, i.e. in the example first part 101 towards right and second part 102 towards left. Equivalently as in the example of FIG. 4a, the stoppers stop and limit the movement. The movement of the shuttle 103 is stopped by the stopper 106 of the shuttle 103 and the stopper 108 of the second part 102. The cradle 103 is generally floating between the first 101 and the second part 102. However a friction between the connections to the parts 101 and 102 moves the shuttle into the respective direction, i.e. opening or closing. When the stoppers 106 and 108 have meet, the stoppers 104 and 105 may not have meet and the slider 101 move further until the stoppers 104 and 105 stops and limit the movement of the slider 101.

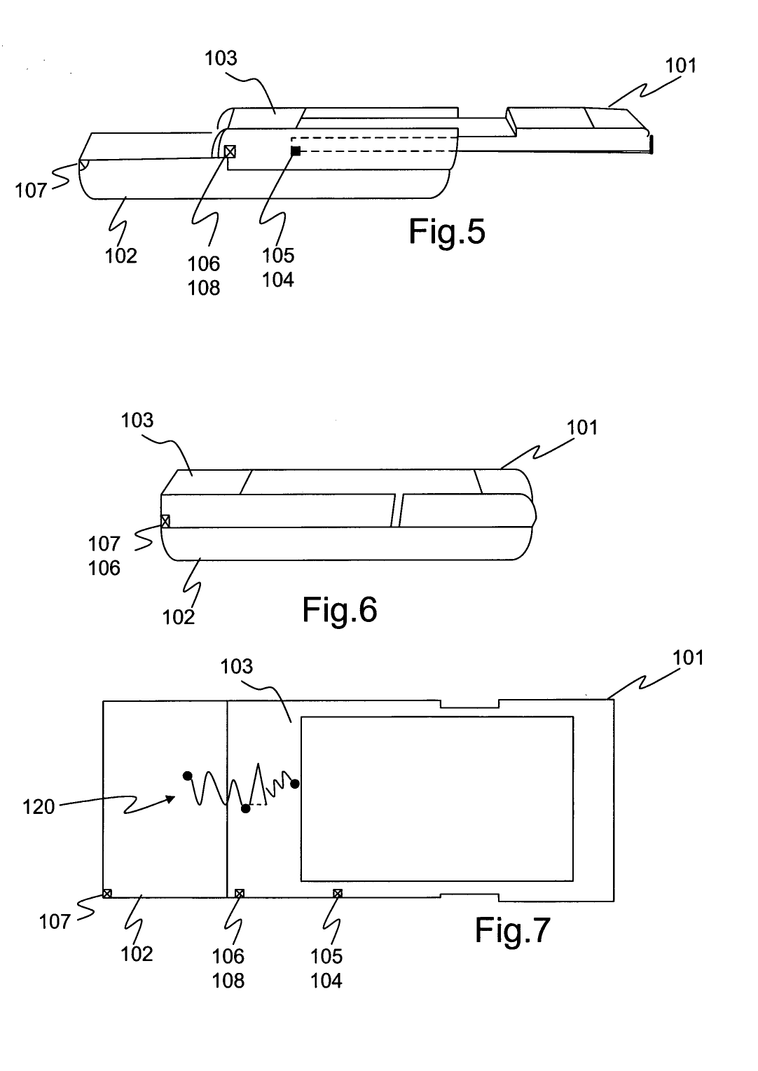

FIG. 5 depicts another example of the apparatus 100 in the open position showing also the stoppers according to various further embodiments of the invention. The locations of the stoppers 104,105 & 106,108 and 107 are shown in the FIG. 5. A further embodiment of the shuttle 103 has been depicted also. FIG. 6 depicts another example of the apparatus 100 in the closed position showing also the stoppers according to various further embodiments of the invention. In the FIG. 6 the stoppers 106 and 107 are shown. FIG. 7 depicts a top view of the apparatus 100, wherein schematic positions of the stoppers 104,105, 106,108 and 107 have been depicted in accordance with further embodiments of the invention. An example of the resilient connection 120 is also shown in FIG. 7. Resilient connection may be implemented by resilient members, such as bars springs, leaves, etc. Further embodiments of FIGS. 5-7 depicts the shutters located at one side of the apparatus. It should be noted that in some further embodiments the shutters may be also located at the other, for example opposed, side of the apparatus.

The resilient connection 120 is arranged so that when the shuttle 103 moves the first part 101 with respect to the second part 102, once a certain position with respect to the resilient connection 120 is reached, a direction of a force of the resilient connection is arranged to be changed into substantially opposite direction, thereby the force of the resilient connection is arranged to move the first part 101 further to the open position. This is when going from the closed mode into the open mode. When going from the open mode into the closed mode the shuttle 103 configured to move the first part 101 with respect to the second part 102 so that once said certain position with respect to the resilient connection 120 is reached, wherein a direction of a force of the resilient connection is arranged to be changed into substantially opposite direction, the force of the resilient connection is arranged to move the first part 101 into the closed position.

Some further embodiments of the invention contain software and/or middleware components so that depending on the position or location of the shuttle, functions and operations of the apparatus may be controlled and performed. The software may be in for of tangible object such as a medium or the like, e.g. a memory. For example, when the shuttle and the apparatus is in closed mode the display is configured to be in power save mode. When the shuttle is in open mode, the display is arranged to be invoked. For another example moving the shuttle slight so that the equilibrium position is not passed by the functions of the apparatus can be changed. For example a different operation mode of the apparatus can be changed, e.g. from calling mode into an internet mode etc. Various different applications and appliances can be set accordingly.

### RAMIFICATIONS AND SCOPE

Although the description above contains many specifics, these are merely provided to illustrate the invention and should not be construed as limitations of the invention's scope. It should be also noted that the many specifics can be combined in various ways in a single or multiple embodiments. Thus it will be apparent to those skilled in the art that various modifications and variations can be made in the apparatuses and processes of the present invention without departing from the spirit or scope of the invention.

1.-30. (canceled)

31. An apparatus, comprising:
a first part;
a second part, wherein the first part is arranged to be slidably and resiliently connected with the second part; and
a third part configured to move the first part with respect to the second part in a direction such that the first part is configured for movement relative to the third part along a path in the direction.

32. An apparatus according to claim 31, wherein first part is arranged to move relative to the third part when a substantial equilibrium position has been passed.

33. An apparatus according to claim 31, wherein the first part is arranged to move automatically by the force of the resilient connection when the equilibrium position is passed.

34. An apparatus according to claim 31, wherein the third part comprises a shuttle, which is configured to move the first part with respect to the second part such that once a substantial equilibrium position with respect to the sliding connection between the first part and the second part is passed, wherein a direction of a force of the resilient connection is arranged to be changed into substantially opposite direction with respect to the movement of the first part, the force of the resilient connection is arranged to move the first part into the movement direction of the shuttle.

35. An apparatus according to claim 31, wherein the first part comprises a cover of the apparatus, the second part comprises a body of the apparatus and the third part comprises a shuttle.

36. An apparatus according to claim 31, wherein the first part comprises a display of the apparatus.

37. An apparatus according to claim 31, wherein the first part is arranged to move towards a closed position of the apparatus.

38. An apparatus according to claim 37, wherein the first part comprises a display of the apparatus and a portion of the display is arranged to be visible in the closed position.

39. An apparatus according to claim 31, wherein the first part is arranged to move towards an open position of the apparatus.

40. An apparatus according to claim 39, wherein the first part comprises a display of the apparatus and a major portion of the display is arranged to be visible in the open position.

41. An apparatus according to claim 40, wherein said major portion correspondences with a widescreen display.

42. An apparatus according to claim 31, wherein the third part comprises a shuttle containing at least a portion of a keypad of the apparatus and wherein the portion of the keypad is visible and usable in both an open position of the apparatus and in a closed position of the apparatus.

43. An apparatus according to claim 31, wherein the second part comprises a full keypad of the apparatus and wherein the full keypad is visible in an open position of the apparatus.

44. An apparatus according to claim 31, wherein at least one of the first part comprises a stopper, the second part comprises a stopper and the third part comprises a stopper, said stopper being configured to limit and stop any of said first, second and third part from moving.

45. An apparatus, comprising:
a first part;
a second part, wherein the first part is arranged to be slidably and resiliently connected to the second part; and
a third part configured to move the first part with respect to the second part in a direction wherein the first part is configured for movement relative to the third part along a path in the direction.

46. An apparatus according to claim 45, wherein first part is arranged to move relative to the third part once a substantial equilibrium position has been passed.

47. An apparatus according to claim 45, wherein the first part is arranged to move automatically by the force of the resilient connection once the equilibrium position is passed.

48. An apparatus according to claim 45, wherein the third part comprises a shuttle, which is configured to move the first part with respect to the second part such that once a substantial equilibrium position with respect to the sliding connection between the first part and the second part is passed, wherein a direction of a force of the resilient connection is arranged to be changed into substantially opposite direction with respect to said direction of the movement of the first part, the force of the resilient connection is arranged to move the first part into the movement direction of the shuttle.

49. An apparatus according claim 45, wherein the apparatus comprises a mobile phone.

50. An apparatus according to claim 45, wherein the apparatus comprises software components configured to change a functional mode of the apparatus according to a position of the third part or according to a position of the first part and wherein the software components are further configured to change a mode of a display of the apparatus according to the position of at least one of the following; the shuttle and the first part.
